(19) United States
(12) Patent Application Publication
(10) Pub. No.: US 2005/0116129 A1
(43) Pub. Date: Jun. 2, 2005

(54) Pipe protector

(76) Inventors: Martin Boudreau, Boisbriand (CA); Jean-Pierre Thibault, Terrebonne (CA)

Correspondence Address: Eric Fincham, 316 Knowlton Road, Lac Brome, QC, J0E 1V0, CA

(21) Appl. No.: 10/966,568

(22) Filed: Oct. 15, 2004

(30) Foreign Application Priority Data
Oct. 17, 2003 (CA) 2,445,498

(51) Int. Cl. F16B 1/00

(52) U.S. Cl. 248/228.7

(57) ABSTRACT

A pipe support which comprises a body having a recess of a generally U-shaped configuration formed therein, the recess being opened at a top end, the body having a clamping portion extending downwardly and which clamping portion includes first and second resilient members which each comprise a vertical sidewall and an inwardly extending end segment. The pipe support is particularly suitable for use on various structural members.

### FIELD OF THE INVENTION

The present invention relates to a pipe support system.

### BACKGROUND OF THE INVENTION

In the installation of pipes and the like in various types of buildings and in particular pipes associated with air conditioning, refrigeration and heating, such as may be employed in commercial and industrial establishments, conventional practice is that the pipes are hung from the ceiling by strap hangers.

The most common type of strap hanger employed in the industry comprises a metal strap having apertures for fastening purposes. The strap is looped about the pipe to be secured and then a fastening member such as a screw or the like is secured to a substrate such as a beam or rafter through the apertures.

This conventional means of fastening pipes suffers from several disadvantages. Initially, each pipe must be installed individually and as such, the installation process is relatively labour intensive. Secondly, the hangers can cause the rupturing of the pipes after a period of time. This would occur due to movement of the pipe within the pipe hanger and subsequent surface damage. The movement will occur either due to mechanical vibrations, and/or to a thermal expansion and contraction.

There have been various proposals in the art for pipe support systems to overcome the above disadvantages. Thus, U.S. Pat. No. 2,273,571 discloses an arrangement wherein one may use a hanger construction which includes the use of a plurality of pipe holders which are movably mounted on a fixed rail.

A further arrangement is shown in U.S. Pat. No. 4,245,806 wherein there is provided a vertically threaded shaft to receive pipe support members of various configurations which are attachable thereto.

U.S. Pat. No. 4,925,136 shows a somewhat similar arrangement wherein there is provided a vertically threaded rod or shaft along with hanger members may be secured thereto.

### SUMMARY OF THE INVENTION

It is an object of the present invention to provide a pipe support system which utilises a minimum of components and tooling while being adaptable for many different pipes and set-ups.

According to one aspect of the present invention, there is provided a pipe support comprising a body having a recess formed therein, the recess having a generally U-shaped configuration and being open at a top end thereof, the recess being defined by a bottom wall and first and second sidewalls, a clamping portion extending downwardly from the body, the clamping portion comprising first and second resilient members, each of the first and second resilient members comprising a vertical sidewall and an inwardly extending end segment.

In a further aspect of the present invention, in a building having a plurality of pipes and structural members, there is provided the improvement which comprises a pipe support assembly secured to at least one of the truss members, the pipe support comprising a body having a plurality of recesses formed therein, the recesses each being of a generally U-shaped configuration and being open at a top end thereof, each of the recesses being defined by bottom wall and first and second sidewalls, the recesses being in a side by side relationship, at least one clamping portion extending downwardly from the body, the clamping portion comprising first and second resilient members, each of the first and second resilient members having a vertical sidewall and an inwardly extending end segment, the vertical sidewalls extending downwardly adjacent sidewalls of the truss member, and the end segments engaging a bottom wall of the truss member.

### BRIEF DESCRIPTION OF THE DRAWINGS

Having thus generally described the invention, reference will be made to the accompanying drawings illustrating an embodiment thereof, in which:

FIG. 1 is a first perspective view of a pipe support member according to an embodiment of the present invention and illustrating the bottom and side thereof;

FIG. 2 is a perspective view of the pipe support member of FIG. 1 illustrating a side and inner portion thereof;

FIG. 3 is a side elevational view thereof;

FIG. 4 is a cross sectional view taken along the lines 4-4 of FIG. 3;

FIG. 5 is a cross sectional view taken along the lines 5-5 of FIG. 3; and

FIG. 6 is a perspective view of a plurality of pipe support members mounted on a structural member.

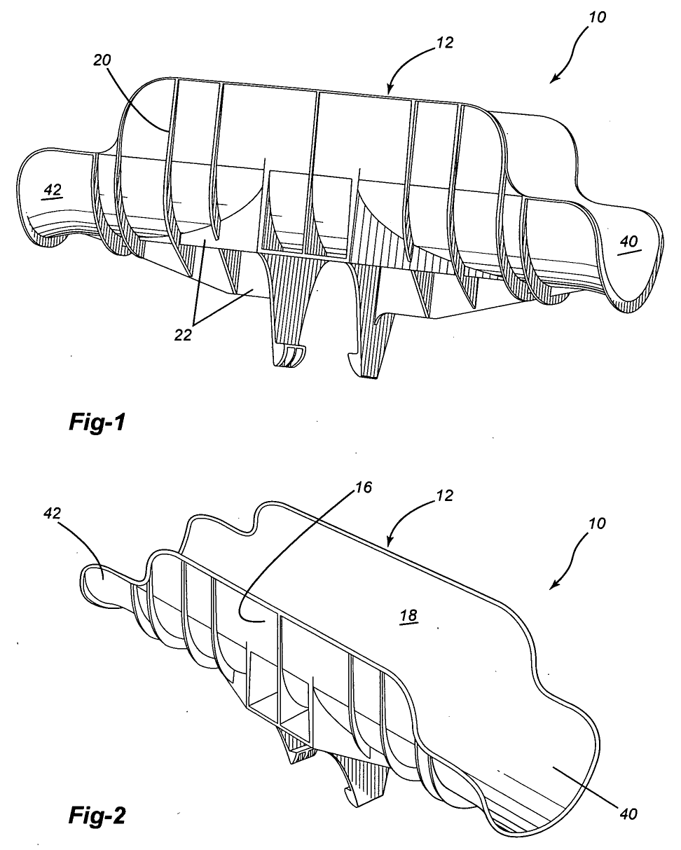

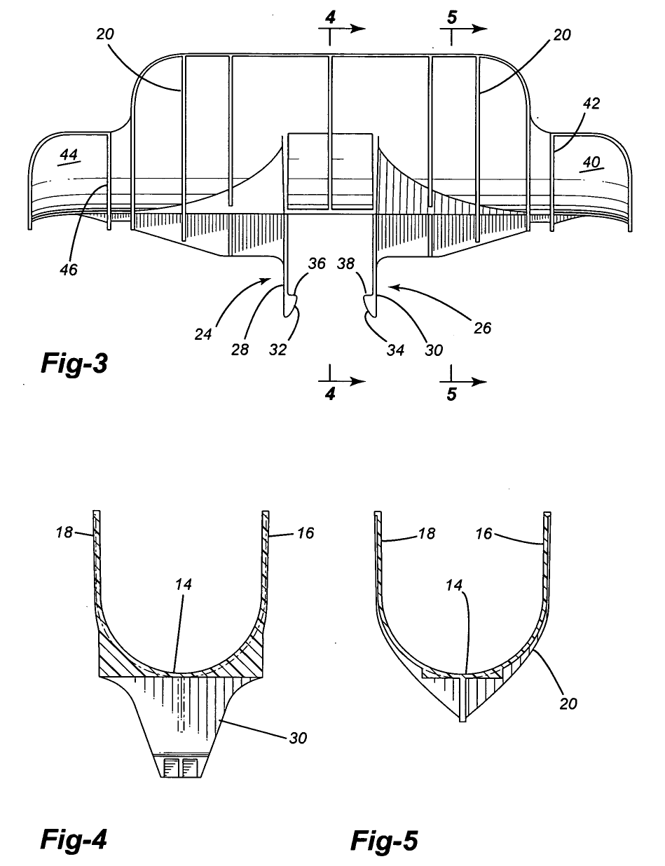

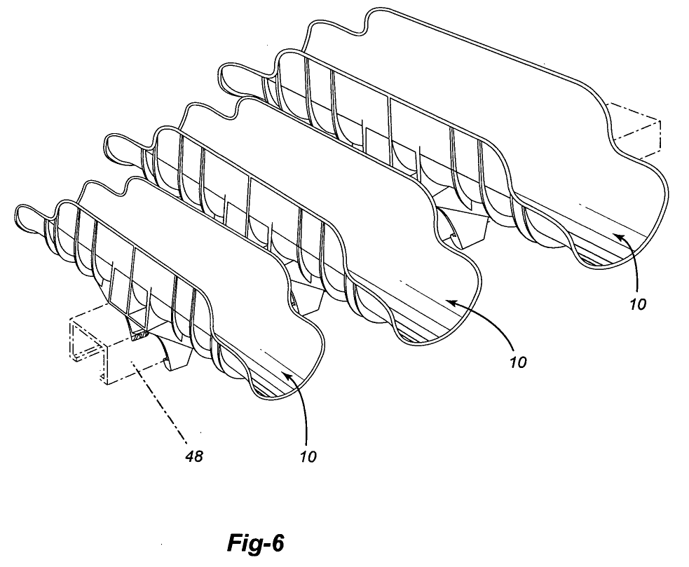

### DESCRIPTION OF THE PREFERRED EMBODIMENTS

Referring to the drawings in greater detail and by reference characters thereto, there is illustrated a pipe support member which is generally designated by reference numeral 10.

Pipe support member 10 includes a central body portion generally designated by reference numeral 12 and which comprises a bottom wall 14 which is of an arcuate configuration and upwardly extending sidewalls 16 and 18.

On the exterior facing surface of bottom wall 14 and sidewalls 16, 18, there are spaced transverse flanges 20. Flanges are also provided along the longitudinal extending flanges 22, three such flanges being illustrated.

The pipe support member 10 is designed to be attached to a truss type support and to this end, there are provided a pair of fastening or clamping members generally designated by reference numerals 24 and 26. Fastening members 24, 26 each have a respective sidewall 28, 30 which extends outwardly from the bottom wall 14. Each sidewall 28, 30 in turn has respective inwardly extending end segments 32, 34. End segments 32, 34 have a respective end wall 36, 38 such that there is defined therebetween a recess designed to fit around a truss member. Naturally, it will be understood that sidewalls 28, 30 are somewhat flexible or resilient.

At one end of pipe support member 10, there is provided an extended tongue portion generally designated by reference numeral 40, and which has a reinforcing rib 42 extending thereabout. Similarly, at the opposed end of central body portion 12, there is provided a second extended tongue 44 having associated rib 46. Each of tongue portions 40, 44 is characterized by a sidewall which is of a lesser height than a central portion of the side walls.

As illustrated in FIG. 5, a number of such support members may be attached to a truss member 48, each designed to receive a single pipe or a conduit.

Naturally, it will be understood that the pipe support member 10 may be made in varying sizes depending upon the particular pipe or conduit which is to be supported. Similarly, the pipe support member 10 can be made of differing materials with a plastic material such as polypropylene being preferred.

It will be understood that the above described embodiments are for purposes of illustration only and changes and modifications may be made thereto without departing from the spirit and scope of the invention.

1. A pipe support comprising:
a body having a recess formed therein, said recess having a generally U-shaped configuration and being open at a top end thereof;
said recess being defined by a bottom wall and first and second sidewalls;
a clamping portion extending downwardly from said body, said clamping portion comprising first and second resilient members;
each of said first and second resilient members comprising a vertical sidewall and an inwardly extending end segment.

2. The pipe hanger of claim 1 wherein said pipe hanger is formed of a plastic material.

3. The pipe support member of claim 2 wherein said first and second sidewalls each have a central portion and a pair of end portions, said central portion extending upwardly from said bottom wall a greater distance than said end portions.

4. The pipe support of claim 2 further including a plurality of exterior ribs formed on said bottom wall and said first and second sidewalls.

5. In a building having a plurality of pipes and structural members, the improvement comprising a pipe support assembly secured to at least one of said truss members, said pipe support comprising:
a body having a plurality of recesses formed therein, said recesses each being of a generally U-shaped configuration and being open at a top end thereof;
each of said recesses being defined by bottom wall and first and second sidewalls, said recesses being in a side by side relationship;
at least one clamping portion extending downwardly from said body, said clamping portion comprising first and second resilient members;
each of said first and second resilient members having a vertical sidewall and an inwardly extending end segment, said vertical sidewalls extending downwardly adjacent sidewalls of said truss member, and said end segments engaging a bottom wall of said truss member.
